(19) United States
(12) Patent Application Publication
(10) Pub. No.: US 2020/0150040 A1
(43) Pub. Date: May 14, 2020

(54) UVABC LED LIGHT

(71) Applicants: JOEL GROSS, BROOKLYN, NY (US); JOHN LUK, QUEENS, NY (US)

(72) Inventors: JOEL GROSS, BROOKLYN, NY (US); JOHN LUK, QUEENS, NY (US)

(73) Assignee: LIGHTING AND SUPPLIES, INC., BROOKLYN, NY (US)

(21) Appl. No.: 16/674,174

(22) Filed: Nov. 5, 2019

Related U.S. Application Data
(60) Provisional application No. 62/757,812, filed on Nov. 9, 2018.

(51) Int. Cl. G01N 21/64

(52) U.S. Cl. CPC G01N 21/6447; G01N 2201/0627

(57) ABSTRACT

The present invention is directed to a device consisting of a portable hand-held and battery operated multi-band UVABC light that uses a combination of UVA, UVB, and UVC wavelength band of UV LED emitters. All three types of UV LEDs are energized at the same time or individually to the same at least one target object being at least one smoke collection holder and capturing device having a coated surface that will fluoresce and glow when there is the presence of a wide range of smoke chemical particulates that have been collected, captured, and held in the at least one smoke collection holder and capturing device. This positive detection and confirmation indicates an act of smoking had recently occurred in the space where the at least one smoke collection holder and capturing device was installed, necessitating additional affirmation testing and recovery costs charged back to the smoker or occupant of the space where the act of smoking had taken place.

### PRIORITY APPLICATION:

The present application claims the benefit and earlier filing date of Application No. 62/757,812 filed on Nov. 9, 2018 entitled, “UVABC Light”.

### FIELD OF THE INVENTION

The present invention relates to a device for detecting and confirming the presence of smoke and vapor from acts of smoking in hotel rooms, public bathrooms, rental vehicles, cruise ships, etc. This device is intended to operate with CSI Group's PCSD (Passive Covert Smoking Detectors) that collect, capture, and hold chemical components from acts of smoking that will react to one or more UV excitation wavelengths.

### BACKGROUND OF THE INVENTION

No Smoking laws have been abused by many individuals who continue to smoke in non-designated areas, thereby causing harm to the general public's health, well-being, and personal safety. There are also the potential liabilities and damages that can arise from fires that are caused from an unattended lit cigarette or other smoking device. In addition, smoke residue and smelly lingering odor is often left behind in the clothing, furniture, carpets, or upholstery that may be in the space where the act of smoking had occurred. This presents increased costs and lost revenues in the additional cleaning and disinfecting required to eliminate the odiferous smell and offensive odor.

Smoke detectors have been installed to try and prevent individuals from smoking in a specific space, but these devices can easily be tampered with and disabled.

There are many patents addressing various methods and UV light sources for improved smoke detectors. U.S. Pat. No. 3,982,130 issued to Trumble on Sep. 21, 1976 entitled, “Ultraviolet Wavelength Smoke Detector” discloses a smoke detector that uses specifically two different UV wavelengths, and where the two wavelengths are dimensionally shorter than the smoke particle diameters that are being detected. The present invention uses all three different UV wavelength ranges to detect a wider band of smoke particulates from various types of smoking devices and materials.

U.S. Pat. No. 6,630,682 issued to Shanley et al. on Oct. 7, 2003 entitled, “Combination UV Inspection Light and Flashlight” discloses a light that combines two different light sources consisting of a UV light source with a full spectrum white light source. For example, the UV light source has a wavelength in the UVA band range from 350 nm to 450 nm in combination with a full spectrum white light source with wavelengths greater than 450 nm, or the UV light source has a wavelength in the UVB band range from 320 nm to 380 nm in combination with a full spectrum white light source with wavelengths greater than 400 nm. The present invention uses a combination of all three types of UV LEDs in multiple UV wavelength band ranges of UVA, UVB, and UVC light with no other wavelengths of light greater than 450 nm.

U.S. Pat. No. 7,564,365 issued to Marman et al. on Jul. 21, 2009 entitled, “Smoke Detection and Method of Detecting Smoke” discloses a smoke detector having a first light source emitting light to a target area in a first wavelength range, and a second light source emitting light to a different target area in a second wavelength range. The first wavelength range can be in the infra-red wavelength range, and is different from the second wavelength range that can be in the ultra-violet wavelength range. The present invention uses a combination of all three types of UV LEDs in multiple UV wavelength band ranges of UVA, UVB, and UVC light with no IR wavelengths. All UV LED light from the three types of UVABC LED light output bands are projected to the same target area for the detection of any smoke particulates that may be present in a smoke collection holder.

U.S. Pat. No. 8,804,119 issued to Knox et al. on Aug. 12, 2014 entitled, “Particle Detection” discloses a system with one or more of light emitters adapted to emit light at a respective wavelength, and wherein a light source is configured to illuminate the volume being monitored at each of the at least two wavelengths at different times. The present invention uses a combination of all three types of UV LEDs in multiple UV wavelength band ranges of UVA, UVB, and UVC light that are all energized at the same time or individually to the same target area for the detection of any smoke particulates that may be present in a smoke collection holder.

Lastly, U.S. Pat. No. 9,669,121 issued to Liao et al. on Jun. 6, 2017 entitled, “Ultraviolet Light Source and Methods” discloses a method for a hand-held device that firstly illuminates an object surface with a first UV LED, and secondly illuminates the same object surface with a second UV LED after some internal calculations and user selection is made. The first UV LED is within the UVA band, and the second UV LED is within the UVC band. The present invention uses a combination of all three types of UV LEDs in multiple UV wavelength band ranges of UVA, UVB, and UVC light that may be all energized at the same time or individually to the same target area for the detection of any smoke particulates that may be present in a smoke collection holder.

There becomes a need for a tamper-proof device that can collect, capture, and hold smoke and vapor from acts of smoking in hotel rooms, bathrooms, rental vehicles, and cruise ships. This device incorporates CSI Group's HFC energy cure coatings technology that is protected under a separate patent application.

There is also a need for a UV light that can simultaneously or individually generate the entire UVA, UVB, and UVC wavelength band ranges for the quickest detection and confirmation of the presence of a wider range of smoke particulates produced by an act of smoking that may be contained in smoke capturing devices or smoke collection holders.

From a chemical compounds standpoint, CSI Group's Passive Covert Smoking Detectors (PCSD) capture and hold acts of smoking chemical components that have UV excitation wavelengths in the following ranges:
Nicotine (all 4 major forms)—220 nm to 280 nm
Tar—400 nm
THC (all 3 major forms)—220 nm to 300 nm
Polycyclic aromatic hydrocarbons—370 nm to 490 nm
Propylene glycol and/or vegetable glycerin—300 nm to 450 nm

A UV light device for detecting one or more of the different types of smoking chemical components is needed to work in conjunction with the smoke collection holder and capturing device. The detection is through classic excitation fluorescence through the use of UV light in the following wavelengths:
UVA—400 nm to 315 nm
UVB—315 nm to 280 nm
UVC—280 nm to 200 nm
   The UV light device when activated will fluoresce the contents of the smoke collection holder and capturing device when any smoking chemical component is present inside the smoke collection holder and capturing device to indicate an act of smoking has occurred in the space where the smoke collection holder and capturing device is covertly installed and located.

The present invention of a UV light device for smoke detection contains at least one UV LED each that emits UV light wavelengths in the UVA, UVB, and UVC frequency range installed in the same UV light device. Activation of the individual UV LEDs in their respective wavelengths and frequency ranges can be done in solo, or in combination with other UV LEDs. For example, UVA or UVB or UVC only; or UVA and UVB, or UVB and UVC, or UVA and UVC; or UVA and UVB and UVC all activated at the same time. The activation of the different types of UV light will provide a general indication of what type of smoking chemical component was present in the space prior to the detection and confirmation with the UV light device. The quickest and fastest confirmation testing is to have all the UVA, UVB, and UVC LEDs turned on at the same time to confirm if any smoking chemical components may have been collected and captured in the PCSD, or similar smoke collection holder and capturing device.

### SUMMARY OF THE INVENTION

The subject invention consists of a small, portable, hand-held, and battery operated UVABC LED light having one or a plurality of UV LEDs emitting at the UVA, UVB, and UVC wavelength bands to allow users to detect the presence of chemical compounds through fluorescing the proprietary smoke capturing devices.

In general, the device of the present invention is only one part of an entire smoke detecting system consisting of the collection, detection, confirmation, and affirmation of smoke particulates that may be present in any given space resulting from acts of smoking.

Collection is done by small, compact, and discreet smoke capturing devices or smoke collection holders that are covertly installed into hotel rooms, bathrooms, rental vehicles, cruise ship state rooms, etc. where acts of smoking may be prohibited. Collection is done by incorporating CSI Group's proprietary HFC energy cure coatings technology.

Detection is performed by a staff member or worker who will use the multi-band UVABC LED light of the present invention to confirm the presence of smoke particulates that is collected in the smoke capturing devices or smoke collection holders, by shining the UVABC LED light directly into the smoke collection holder and capturing devices. The multi-band UVABC LED light of the present invention will be designed and manufactured by Lighting and Supplies, Inc. and its subsidiary Sunshine Lighting Company exclusively for CSI Group of Companies for use with their PCSD Passive Covert Smoking Detectors.

If the smoke collection holder and capturing device fluoresces in the multi-band UVABC LED light, then there is a positive confirmation that an act of smoking was recently present in the space where the smoke collection holder and capturing device was immediately located. A bright glow indicates a more recent act of smoking was present, while a dim glow indicates an act of smoking had occurred some time ago. No glow at all shows no immediate act of smoking was present.

Once there is a positive confirmation of an act of smoking has occurred, the final step of affirmation is to send the smoke collection holder and capturing device out to a secondary scientific detection company for specified analytical measurement of FTIR (Fourier Transform Infrared Spectroscopy) testing conducted by a licensed analytical laboratory like Intertek Labs or equivalent testing lab. The resultant test report becomes legal evidence to show that an act of smoking was performed with detailed findings down to the specific type of smoking done along and all chemical traces found in the tested space that can be tied back to the last occupant or user of the space.

It then becomes a first object of this invention to introduce a quick and simple device to confirm the presence of smoke particulates in a proprietary PCSD indicating an act of smoking was committed.

It is another object of this invention to incorporate a combination of UV LEDs in which at least one first UV LED emits in the UVA range wavelength band, at least one second UV LED emits in the UVB range wavelength band, and at least one third UV LED emits in the UVC range wavelength band, all UV LEDs are to be energized together primarily at the same time or individually to the same target object area.

It is yet another object of this invention to provide a complete UV light output in the wavelength range from 200 nm to 400 nm inclusively containing all wavelengths of UV light in the UVA, UVB, and UVC wavelength band ranges.

It is a final object of this invention to allow the users of the present invention in combination with the proprietary PCSD, or a similar smoke collection holder and capturing device to turn hundreds of millions in losses annually into EBIDTA profits using scientific collection, detection, confirmation, and affirmation of acts of smoking through recovery charges.

A power switch is used to power up the multi-band UVABC LED light source whose primary operation is to turn on all three types of UV LEDs consisting of one or more of UVA, UVB, and UVC each in their respective wavelength band ranges. The power switch can be a simple ON/OFF switch, or it can be a momentary type switch that will send power from batteries located inside the UVABC LED light directly to the UV LEDs when the power switch is activated. The preferred use of a momentary type switch ensures the UVABC LED light will not be drained of battery power in case the user forgets to turn the power switch off and disconnect battery power to the UV LEDs.

As an addition, the power switch can work with a separate 4-way type switch that can turn on each at least one UVA LED, at least one UVB LED, or at least one UVC LED with another setting to send power to all of the UV LEDs. Or the power switch can incorporate the 4-way switching internally to reduce hardware. This method will help to narrow down the type of smoke particulate that may be in the smoke collection holder and capturing device depending in which one or more than one of the UVA, UVB, or UVC LEDs fluoresces the smoke particles in the smoke collection holder and capturing device.

In one embodiment, the multi-band UVABC LED light is a portable UV flash light. The portable UV flash light is compact and consists of a front LED housing containing at least one each of a UVA, UVB, and UVC LED mounted onto a circuit board. There is a clear lens made of acrylic plastic or quartz glass that will not absorb, but will transmit all UV wavelengths of light. It will also serve as a protective barrier to prevent damage to the UV LEDs, and will help keep the UV LEDs free from dirt and dust. In the middle section of the portable UV flash light is the battery compartment. The rear section of the portable UV flash light is the power switch mechanism and related electronics to deliver power from the battery to energize the UV LEDs when the power switch is activated. Lastly, an optional hanging strap is provided on the portable UV flash light for the user to safely stow away the UV flash light on a hook or other hanging means when the portable UV flash light is not in use.

In another embodiment, the multi-band UVABC LED light is a portable UV flood light. The portable UV flood light is small and consists of a front LED housing containing at least one group each of UVA, UVB, and UVC LEDs all mounted onto a circuit board. There is a clear lens made of acrylic plastic or quartz glass that will not absorb, but will transmit all UV wavelengths of light. It will also serve as a protective barrier to prevent damage to the UV LEDs, and will help keep the UV LEDs free from dirt and dust. In the middle section of the portable UV flood light is the power switch mechanism and related electronics to deliver the power from the battery to energize the UV LEDs when the power switch is activated. The rear section of the portable UV flood light is the battery compartment. Lastly, a yoke bracket is provided on the portable UV flood light for the user to safely mount the UV flood light on a hook, stand, or onto a flat surface when the portable UV flood light is not in use. The yoke bracket can serve as a stand for focusing the portable UV flood light if necessary.

In other embodiments of the present invention, the multi-band UVABC LED light can be made to be rechargeable, water resistant incorporating O-rings and gaskets, or have an integral power supply cord and plug for the multi-band UVABC LED light to be connected directly to a permanent source of input power.

These and other aspects, features, and advantages of the present invention will become more readily apparent from the following attached drawings and the detailed description of the preferred and alternate embodiments.

### TABLE OF NUMERALS

First Preferred Embodiment (FIG. 1, FIG. 2, and FIG. 3)
10 Multi-band UVABC LED flash light
20 LED compartment
30 Battery compartment
40 Switch mechanism and electronics compartment
50 Power switch
60 UV LEDs
70 Circuit board
80 UVA LED(s)
90 UVB LED(s)
100 UVC LED(s)
110 Protective lens
120 Hanging strap (optional)

Second Alternate Embodiment (FIG. 4 and FIG. 5)
130 Multi-band UVABC LED flood light
140 LED compartment
150 Battery compartment
160 Switch mechanism and electronics compartment
170 Power switch
180 UV LEDs
190 Circuit board
200 UVA LED(s)
210 UVB LED(s)
220 UVC LED(s)
230 Protective lens
240 Yoke mounting bracket (optional)

Bench Test Circuit (FIG. 6)
250 Test circuit
260 UV LEDs
270 UVA LED(s)
280 UVB LED(s)
290 UVC LED(s)
300 LED driver IC
310 Power switch
320 Battery
330 Inductor
340 Input capacitor
350 Output capacitor
360 Resistor

Preferred circuit boards (FIG. 7 and FIG. 8)
370 Round circuit board
380 UV LEDs
390 UVA LED(s)
400 UVB LED(s)
410 UVC LED(s)
420 Square circuit board
430 UV LEDs
440 UVA LED(s)
450 UVB LED(s)
460 UVC LED(s)

Preferred electrical circuit (FIG. 9)
470 Electrical circuit
480 LED driver IC
490 UV LEDs
500 UVA LED(s)
510 UVB LED(s)
520 UVC LED(s)
530 Power switch
540 Rechargeable battery
550 Inductor
560 Input capacitor
570 Output capacitor
580 Resistor

Alternate circuit boards (FIG. 10 and FIG. 11)
590 Round circuit board
600 UV LEDs
610 UVA LED(s)
620 UVB LED(s)
630 UVC LED(s)
640 Square circuit board
650 UV LEDs
660 UVA LED(s)
670 UVB LED(s)
680 UVC LED(s)

Alternate electrical circuit (FIG. 12)
690 Electrical circuit
700 LED driver IC
710 UV LEDs
720 UVA LED(s)
730 UVB LED(s)
740 UVC LED(s)
750 Power switch
760 Rechargeable battery
770 Inductor
780 Input capacitor
790 Output capacitor
800 Resistor

### BRIEF DESCRIPTION OF THE DRAWINGS

The preferred and alternate embodiments of the present invention will be described in conjunction with the appended drawings provided to illustrate and not to the limit the invention, where like designations denote like elements, and in which:

FIG. 1 shows isometric views of a first preferred embodiment of a multi-band UV LED flash light for confirming the presence of smoke particulates.

FIG. 2 shows rendered views of two multi-band UV LED flash lights showing the front, middle, and rear of the preferred embodiment of the present invention as shown in FIG. 1.

FIG. 3 shows a rendered view of a first preferred embodiment of a multi-band UVABC LED flash light showing additional detail of the optional hanging strap.

FIG. 4 shows isometric views of a second alternate embodiment of a multi-band UV LED flood light for confirming the presence of smoke particulates.

FIG. 5 shows a rendered view of a second alternate embodiment of a multi-band UVABC LED flood light showing additional detail of the optional yoke mounting bracket.

FIG. 6 shows a bench test circuit with one each of a UVA, UVB, and UVC LED to inspect a Passive Covert Smoking Detector and to validate a proof of concept.

FIG. 7 shows a top view of a preferred round circuit board populated with UV LED packages available from Seoul Viosys.

FIG. 8 shows a top view of a preferred square circuit board populated with UV LED packages available from Seoul Viosys.

FIG. 9 shows a schematic of a preferred electrical circuit used in the present invention consisting of an LED driver IC, UV LEDs from Seoul Viosys, a power switch, and related electronic components with a rechargeable battery for providing power to the UVABC LED light.

FIG. 10 shows a top view of an alternate round circuit board populated with UV LED packages available from LG Innotek.

FIG. 11 shows a top view of an alternate square circuit board populated with UV LED packages available from LG Innotek.

FIG. 12 shows a schematic of an alternate electrical circuit used in the present invention consisting of an LED driver IC, UV LEDs from LG Innotek, a power switch, and related electronic components with a rechargeable battery for providing power to the UVABC LED light.

### DETAILED DESCRIPTION

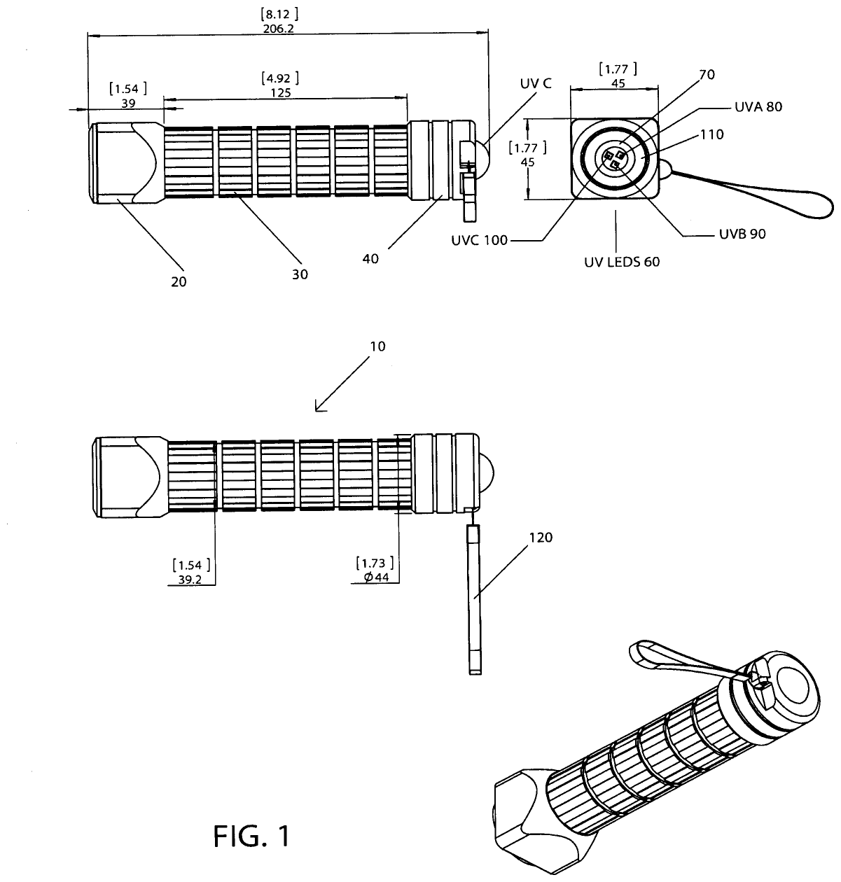

FIG. 1 shows isometric views of a first preferred embodiment of a multi-band UV LED flash light 10 for confirming the presence of smoke particulates (not shown). The portable UV flash light 10 is compact and consists of a front LED housing 20 containing at least one each of a UVA 80, UVB 90, and UVC 100 UV LEDs 60 mounted onto a circuit board 70. There is a clear protective lens 110 made of acrylic plastic or quartz glass that will not absorb, but will transmit all UV wavelengths of light. It will also serve as a protective barrier to prevent damage to the UV LEDs 60, and will help keep the UV LEDs 60 free from dirt and dust. In the middle section of the portable UV flash light 10 is the battery compartment 30. The rear section of the portable UV flash light 10 is the power switch 50 mechanism and related electronics 40 to deliver power from the battery (not shown) to energize the UV LEDs 60 when the power switch 50 is activated. Lastly, an optional hanging strap 120 is provided on the portable UV flash light 10 for the user to safely stow away the UV flash light 10 on a hook or other hanging means when the portable UV flash light 10 is not in use.

The UV LED flash light 10 of the first preferred embodiment of FIG. 1 utilizes one UV LED 60 each available in different wavelengths in the band ranges of UVA 80, UVB 90, and UVC 100. The UV LED emitter chips can be obtained from manufacturers including Seoul Viosys, LG Innotek, Philips Lumileds, or International Light Technologies, etc. that can offer similar packaging and operational specifications. The UV LEDs 60 are available in 0.2 W, 0.5 W, and 1.0 W for each UVA 80, UVB 90, and UVC 100 emitter. This equates to a total wattage for the UV LED flash light 10 to be either 0.6 W (3×0.2 W), 1.5 W (3×0.5 W), or 3.0 W (3×1.0 W). The intended battery (not shown) to be used in this UV LED flash light 10 is two D-Size 1.5 Vdc type batteries. Other battery types and sizes may be used. When using the 0.2 W emitters, the battery is estimated to last up to 25 hours; using 0.5 W emitters, the battery may last up to 10 hours; and using 1.0 W emitters, the battery may last up to 5 hours. Now given an estimated intermittent use of up to 15 minutes each day by an inspector, the UV LED flash light 10 should last about 100 hours (4×25) or 4.17 days when using 0.2 W emitters; about 40 hours (4×10) or 1.67 days when using 0.5 W emitters; and about 20 hours (4×5) or 0.83 days when using 1.0 W emitters before having to change out or recharge the batteries (not shown).

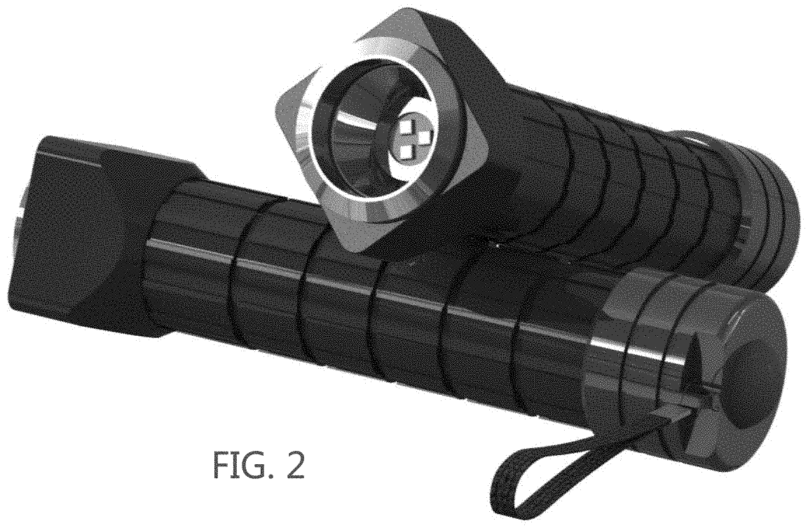

FIG. 2 shows rendered views of two multi-band UV LED flash lights 10 showing the front 20, middle 30, and rear 40 compartments of the preferred embodiment of the present invention as shown in FIG. 1. The UV LED flash lights 10 can utilize soft rubber grips and grooves for tactile handling and to prevent damage to the UV LED flash lights 10 in case they are dropped to a hard floor. The front protective lens 110 is preferably made out of a shatter-proof and durable material to prevent damage and harm to the user if it should see impact. Also, the front 20 and/or rear 40 portions are made with straight edges instead of being round, so as to prevent the UV LED flash lights 10 from rolling off a table or cart. Lastly, the UV LED flash lights 10 can be made available in different colors for better visibility with some flat portions on the main body for private label branding, logos, safety markings, and the like as needed.

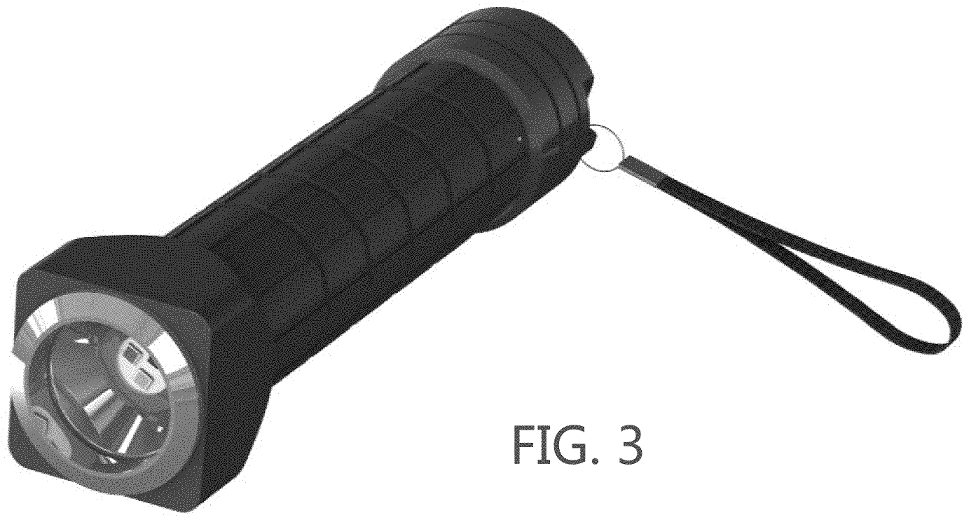

FIG. 3 shows a rendered view of a first preferred embodiment of a multi-band UV LED flash light 10 showing additional detail of the optional hanging strap 120. In lieu of an optional hanging strap 120, a hook, clip, ring or other means can be used to hang the UV LED flash light 10 onto a cart or wall when not in use.

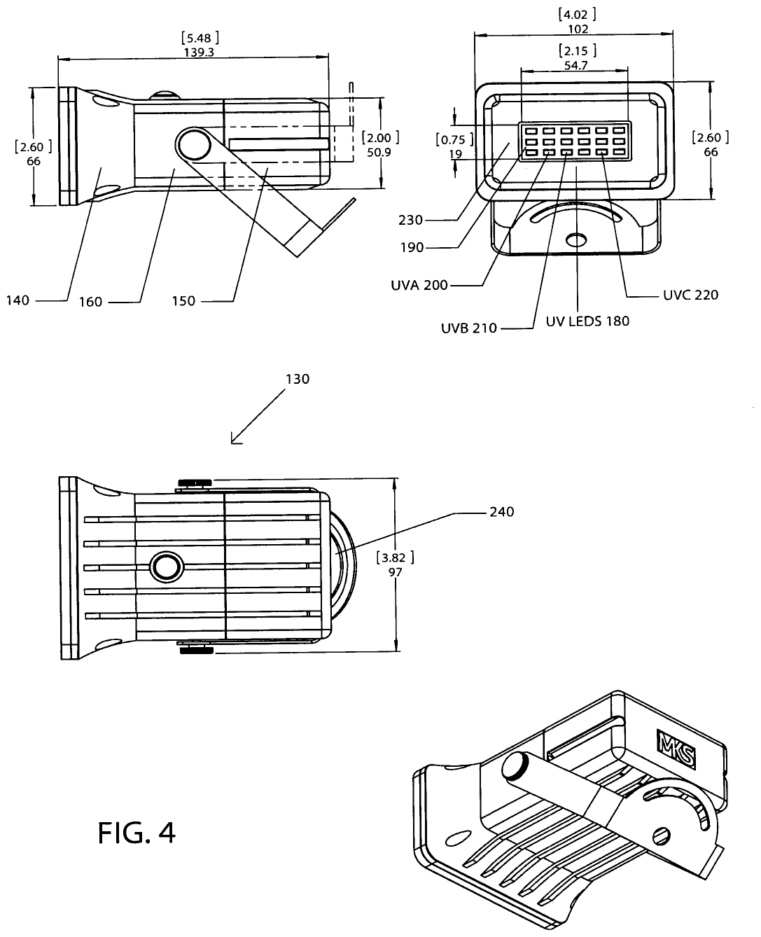

FIG. 4 shows isometric views of a second alternate embodiment of a multi-band UV LED flood light 130 for confirming the presence of smoke particulates (not shown). The portable UV flood light 130 is small and consists of a front LED compartment 140 containing at least one group each of UVA 200, UVB 210, and UVC 220 UV LEDs 180 all mounted onto a circuit board 190. Shown are six each of UV LEDs 180 in each of three groups of UVA 200, UVB 210, and UVC 220 UV LEDs 180. There is a clear protective lens 230 made of acrylic plastic or quartz glass that will not absorb, but will transmit all UV wavelengths of light. It will also serve as a protective barrier to prevent damage to the UV LEDs 180, and will help keep the UV LEDs 180 free from dirt and dust. In the middle section of the portable UV flood light 130 is the power switch mechanism and related electronics 160 to deliver the power from the battery (not shown) to energize the UV LEDs 180 when the power switch 170 is activated. The rear section of the portable UV flood light 130 is the battery compartment 150. Lastly, a yoke bracket 240 is provided on the portable UV flood light 130 for the user to safely mount the UV flood light 130 on a hook, stand, or onto a flat surface when the portable UV flood light 130 is not in use. The optional yoke bracket 240 can serve as a stand for focusing the portable UV flood light 130 if necessary.

UV flood light 130 is preferably made of light weight die-cast aluminum alloy. The finish will be electrostatic matte black paint. The front protective lens 230 is preferably made out of a shatter-proof and durable material to prevent damage and harm to the user if it should see impact. Also, the front 140, middle 160, and rear 150 portions are made with straight edges instead of being round, so as to prevent the UV LED flood light 130 from rolling off a table or cart. Lastly, the UV LED flood light 180 can be made available in different colors for better visibility with some flat portions on the main body for private label branding, logos, safety markings, and the like as needed.

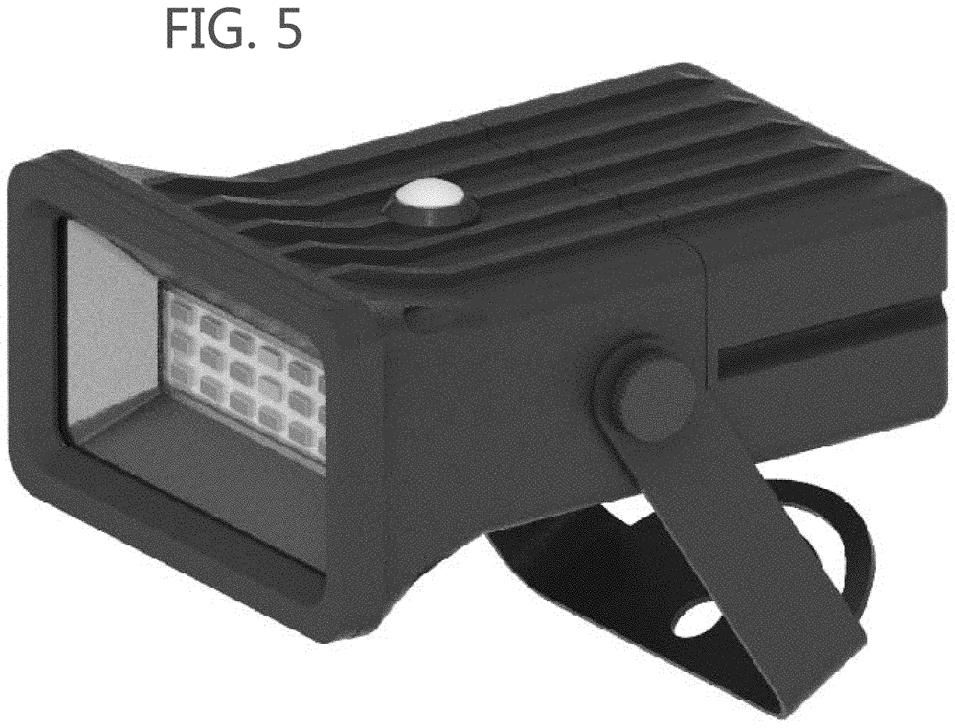

FIG. 5 shows a rendered view of a second alternate embodiment of a multi-band UV LED flood light 130 showing additional detail of the optional yoke mounting bracket 240. The optional yoke mounting bracket 240 can use mounted to a flat surface, a pipe clamp, or a stand if necessary, or it can be a stand for the UV LED flood light 130.

Looking at all of the different excitation wavelengths for the various types of smoking particulates including Nicotine, Tar, THC, Polycyclic Aromatic Hydrocarbons, and Propylene glycol with or without vegetable glycerin; the target UV LED wavelength band ranges should be 365 nm+/−50 nm for the UVA LED(s); 300 nm+/−20 nm for the UVB LED(s); and 240 nm+/−40 nm for the UVC LED(s). This should give a combined total UV light band range of 200 nm to 400 nm coverage from the UVABC light of the present invention to best excite all possible types of smoking chemicals and particulates presently available. Other combined UV light band ranges with varying UVA, UVB, and UVC wavelength band ranges may be used depending on the type of UV LED emitters that are available from different manufacturers of the UV LEDs.

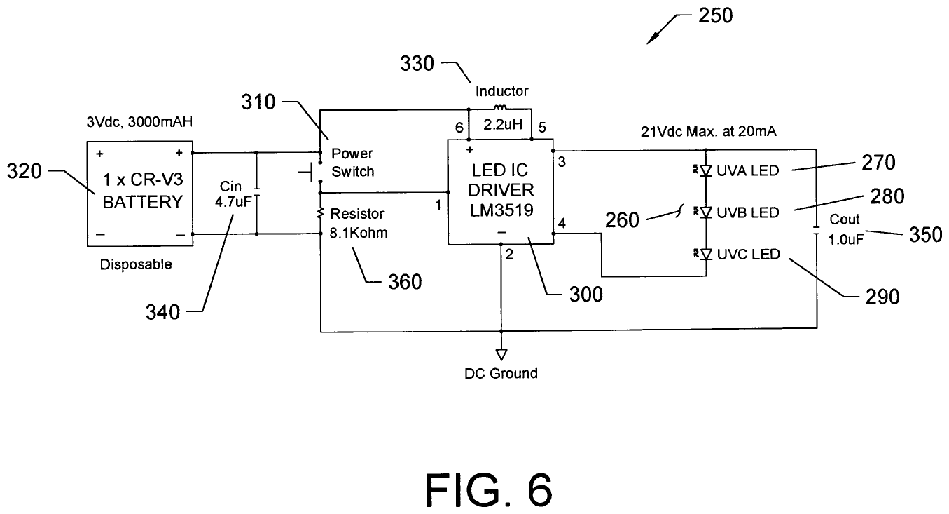

A bench test circuit 250 was developed and used to operate the UV LEDs 260 at a low constant current to test for minimum radiant flux requirements in the specific UV wavelength bands to adequately fluoresce the various smoke chemical particulates. The use of one each of a UVA LED 270, UVB LED 280, and UVC LED 290 will represent the basic number of UV LEDs 260 that can be used to inspect, detect, and confirm the presence of smoke chemical particulates that may be found in a smoke collection holder and capturing device (not shown). FIG. 6 shows a bench test circuit 250 with one each of a UVA LED 270, UVB LED 280, and UVC LED 290 to inspect a Passive Covert Smoking Detector (not shown) and to validate a proof of concept. The test circuit 250 consists of an LED Driver IC 300, UV LEDs 260, a power switch 310, and related electronic components with a disposable battery 320 for providing power to the UVABC LED light.

The LED driver IC 300 of choice here is the Texas Instrument LM3519 high frequency boost white LED driver with high-speed PWM brightness control. The LED driver IC 300 LM3519 can drive up to 4 UV LEDs 260 with constant current in hand-held devices. The LED current is internally set to 20 mA. The series connection allows the LED current to be identical for uniform brightness and minimizes the number of traces to the UV LEDs 260. The LED driver IC 300 LM3519 uses a small number of external components including a 2.2 uH inductor 330, a 4.7 uF input capacitor 340 for the input voltage, and a 1.0 uF output capacitor 350 for the output LED voltage. One end of an 8.1 Kohm resistor 360 is connected to DC Ground to normally connect the LED driver IC 300 Enable pin 1 to zero volts to turn off the DC output to the LEDs. The Enable pin 1 is also connected to a normally open momentary power switch 310.

The test battery 320 is rated at 3 Vdc, 3000 mAH consisting of one CR-V3 type disposable battery 320. The input of the LED driver IC 300 LM3519 has a wide input voltage range of 2.7 Vdc to 5.5 Vdc. It is desirable to have a portable hand-held and battery 320 operated UVABC light 10, 130 to operate for a relatively long time on battery 320 power before having to replace the batteries 320. Using a 3000 mAH rated power source with a constant current output of 20 mA should provide battery 320 power for about 150 hours (3000/20) or 6.25 days (150/24). Since the UVABC light 10, 130 is estimated to be used for 15 minutes a day, the 150 hours of battery 320 power should allow the UVABC LED light 10, 130 to operate for 25 days (6.25/0.25) before having to replace and change out the battery 320.

The output of the LED driver IC 300 LM3519 is rated 21 Vdc at 20 mA. The test UV LEDs 260 are from LG Innotek and distributed by Irtronix, Inc. The UVA LED 270 is the LEUVS33G10TZ00 385 nm 11 mW 3528 LED PKG L/F Type NUV SMD LED; the UVB LED 280 is the LEUVA66G00KF00 305 nm 10 mW 6060 PKG 1-in-1 Flat LED PKG; and the UVC LED 290 is the LEUVK37B50HF00 278 nm 2.5 mW 3535 LED PKG. The forward voltage of the single UVA LED 270 is typically 3.4 Vdc; the forward voltage of the single UVB LED 280 is typically 7.0 Vdc; and the forward voltage of the single UVC LED 290 is typically 7.5 Vdc. The total voltage of the LED string is then 3.4 Vdc+7.0 Vdc+7.5V dc=17.9 Vdc+2.0 Vdc (head room for tolerance)=19.9 Vdc, or about 20V dc that falls below the rated 21 Vdc. At 20 mA×20 Vdc, the UVABC LED test light 10, 130 will be rated maximum 0.4 W or 400 mW.

The UVABC LED light 10, 130 of FIG. 6 was used with a proprietary Passive Covert Smoking Detector (not shown) that was allowed to capture chemical smoke particulates from both cigarette smoking and electronic vapor smoking. Each act of smoking was collected in two individual holders. The holder containing the nicotine cigarette smoke particulates only faintly fluoresced using the UVABC LED light 10, 130 placed six-inches away. The holder containing the PAH smoke particulates fluoresced brightly when using the UVABC LED light placed six-inches away. This indicates the single UVA LED with a wavelength of 385 nm is adequate in radiant flux to fluoresce electronic cigarette vapor with an excitation wavelength from 370 nm to 490 nm for PAH Polycyclic aromatic hydrocarbons. The single UVC LED with a wavelength of 278 nm is not powerful enough to fluoresce nicotine found in cigarette smoke with an excitation wavelength from 220 nm to 280 nm.

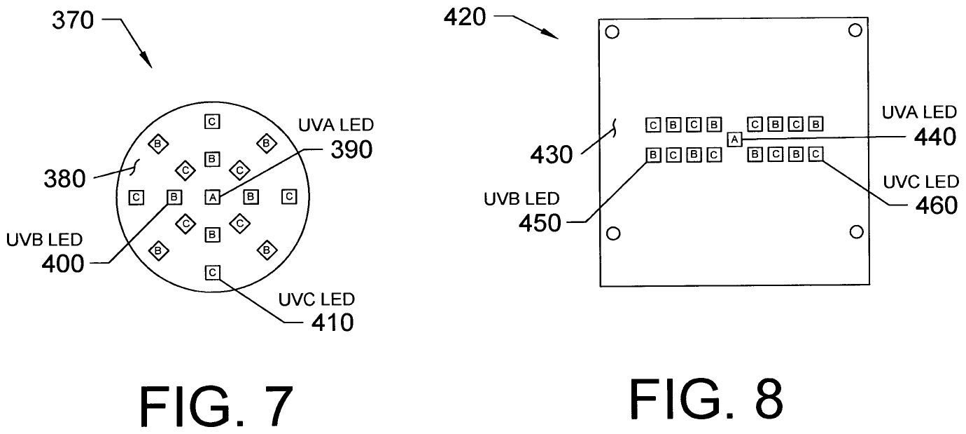

FIG. 7 shows a top view of a preferred round circuit board 370 populated with UV LED 380 packages available from Seoul Viosys. The round circuit board 370 consists of one UVA LED 390 CUN9GF1A CA3535 PKG LED, eight UVB LED 400 CUD1FG1A CA3535 PKG LEDs, and eight UVC LED 410 CUD7GF1A CA3535 PKG LEDs. The round circuit board 370 populated with Seoul Viosys UV LEDs 380 can be use in the preferred embodiment of a UVABC LED flash light 10 of the present invention. These UV LEDs 380 were chosen specifically with dominant wavelengths and main ranks, so that the output radiant flux from each one or group of UV LEDs 380 give out approximately the same intensity when driven at a constant current of 20 mA. The UV LEDs 380 are arranged such that there is a mixed distribution of the UVA LED 390, UVB LED 400, and UVC LED 410 wavelength band ranges when the UVABC LED light 10 is projected to a target inspection area (not shown). The UVA LED 390 is in the center with the UVB LEDs 400 and UVC LEDs 410 each placed concentrically outward from the center in an alternating pattern. This configuration would allow for the even illumination of the chemical smoke particulates that may be present in a smoke collection holder and capturing device like the proprietary PCSD Passive Covert Smoking Detector (not shown).

FIG. 8 shows a top view of a preferred square circuit board 420 populated with UV LED 430 packages available from Seoul Viosys. The square circuit board 420 consists of one UVA LED 440 CUN9GF1A CA3535 PKG LED, eight UVB LED 450 CUD1FG1A CA3535 PKG LEDs, and eight UVC LED 460 CUD7GF1A CA3535 PKG LEDs. The square circuit board 420 populated with Seoul Viosys UV LEDs 430 can be use in the alternate embodiment of a UVABC LED flood light 130 of the present invention. These UV LEDs 430 were chosen specifically with dominant wavelengths and main ranks, so that the output radiant flux from each one or group of UV LEDs 430 give out approximately the same intensity when driven at a constant current of 20 mA. The UV LEDs 430 are arranged such that there is a mixed distribution of the UVA LED 440, UVB LEDs 440, and UVC LEDs 460 wavelength band ranges when the UVABC LED light 130 is projected to a target inspection area (not shown). The UVA LED 440 is in the center with the UVB LEDs 450 and UVC LEDs 460 each placed linearly outward from the center in an alternating pattern. This configuration would allow for the even illumination of the chemical smoke particulates that may be present in a smoke collection holder and capturing device like the proprietary PCSD Passive Covert Smoking Detector (not shown).

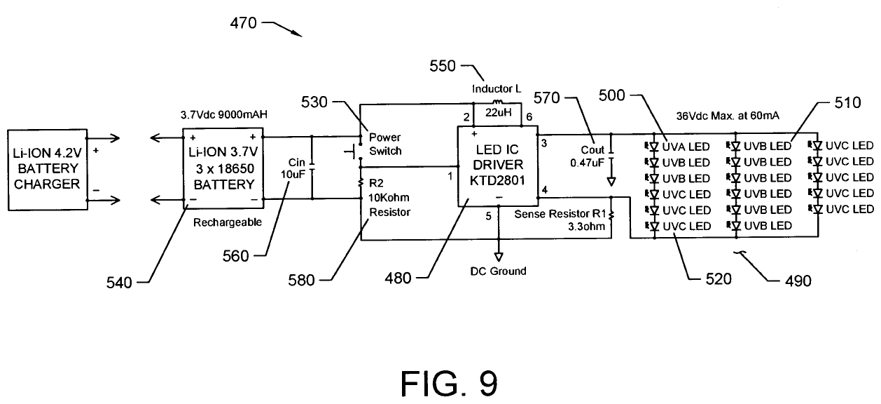

FIG. 9 shows a schematic of a preferred electrical circuit 470 used in the present invention consisting of an LED driver IC 480, UV LEDs 490 from Seoul Viosys, a power switch 530, and related electronic components with a rechargeable battery 540 for providing power to the UVABC LED light 10, 130 for use with the populated round LED circuit board 370 of FIG. 7 and the populated square LED circuit board 420 of FIG. 8. The LED driver IC 480 of choice here is the Kinetic Technologies KTD2801 36V Step-Up LED Driver with Internal Diode and Serial Control. The LED driver IC 480 KTD2801 is a versatile constant current LED driver with a high efficiency DC-DC step up “boost” converter architecture. The low-side power MOSFET and high-side diode are integrated in the device, minimizing the total number of external components. Unique technology and high 520 mA current limit allows the LED driver IC 480 KTD2801 to drive up to 36V output with 10 UV LEDs 490 connected in series. The LED current is set to 60 mA using a 3.3 ohm sense resistor to power three strings of UV LEDs 490 each seeing a constant current of 20 mA each. The series connection allows the LED current to be identical for uniform brightness and minimizes the number of traces to the UV LEDs 490. The LED driver IC 480 KTD2801 uses a small number of external components including a 22 uH inductor 550, a 10 uF input capacitor 560 for the input voltage, and a 0.47 uF output capacitor 570 for the output LED voltage. One end of a 10 Kohm resistor 580 is connected to DC Ground to normally connect the LED Driver IC 480 Control pin 1 to zero volts to turn off the DC output to the UV LEDs 490. The LED driver IC 480 Control pin 1 is also connected to a normally open momentary power switch 530.

The rechargeable battery 540 is rated at 3.7 Vdc, 9000 mAH and consists of three 18650 type 3000 mAH lithium-ion batteries 540 connected in parallel. The input of the LED driver IC 480 KTD2801 has a wide input voltage range of 2.7 Vdc to 5.5 Vdc. It is desirable to have a portable hand-held and battery operated UVABC light 10, 130 to operate for a relatively long time on battery power before having to recharge the batteries 540. Using a combined 9000 mAH rated power source with a constant current output of 60 mA should provide battery 540 power for about 150 hours (9000/60) or 6.25 days (150/24). Since the UVABC light 10, 130 is estimated to be used for 15 minutes a day, the 150 hours of battery 540 power should allow the UVABC LED light 10, 130 to operate for 25 days (6.25/0.25) before having to recharge the batteries 540 with an external battery charger.

The output of the LED driver IC 480KTD2801 is rated 36 Vdc at 60 mA. The UV LEDs 490 are acquired directly from Seoul Viosys Company. The UVA LED 500 is the CUN9GF1A CA3535 PKG UV LED; the UVB LED 510 is the CUD1FG1A CA3535 PKG UV LED; and the UVC LED 520 is the CUD7GF1A CA3535 PKG UV LED. The forward voltage of the single UVA LED 500 is typically 3.4 Vdc; the forward voltage of each UVB LED 510 is typically 5.6 Vdc; and the forward voltage of each UVC LED 520 is typically 6.4 Vdc. The LED driver IC 480 KTD2801 supplies up to 36 Vdc at 60 mA into three LED strings of mixed or same UV LEDs 490 connected in series. Each LED strings sees about 20 mA. The first LED string consists of 1×UVA LED 500, 2×UVB LEDs 510, and 3×UVC LEDs 520 with a combined maximum forward voltage of 3.4v+5.6v+5.6v+6.4v+6.4v+6.4v totaling 33.8 Vdc. The second LED string consists of 6×UVB LEDs 510 with a combined maximum forward voltage of 6×5.6v=33.6 Vdc. The third LED string consists of 5×UVC LEDs 520 with a combined maximum forward voltage of 5×6.4v=32 Vdc. At 60 mA and a maximum of 36 Vdc, the UVABC LED light 10, 130 will be rated about 2.0W using the Seoul Viosys C3535 package UV LEDs 490.

It can be appreciated that someone skilled in the art can use different types and quantities of UV LEDs 490 in the circuit boards 70, 190, 370, 420 and LED driver electronics at different currents and voltages in the circuit boards 70, 190, 370, 420 and circuit of FIG. 7, FIG. 8, and FIG. 9 above to achieve the same or similar results of the present invention for a UVABC LED light 10, 130.

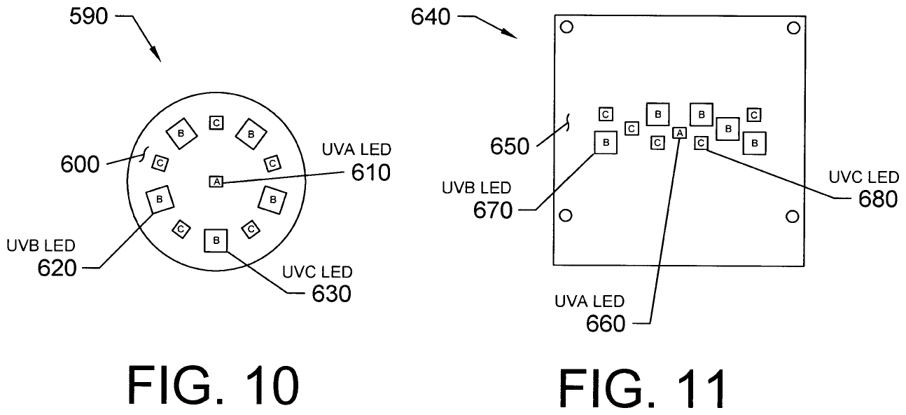

FIG. 10 shows a top view of an alternate round circuit board 590 populated with UV LED 600 packages available from LG Innotek. The round circuit board 590 consists of one UVA LED 610 LEUVS33G10TZ00 385 nm 11 mW 3528 LED PKG L/F Type NUV SMD LED, five UVB LEDs 620 LEUVA66G00KF00 305 nm 10 mW 6060 PKG 1-in-1 Flat LED PKG LEDs, and five UVC LEDs 630 LEUVK37B50HF00 278 nm 2.5 mW 3535 LED PKG LEDs. The round circuit board 590 populated with LG Innotek UV LEDs 600 can be use in the preferred embodiment of a UVABC LED flash light 10 of the present invention. These UV LEDs 600 were chosen specifically with dominant wavelengths and main ranks, so that the output radiant flux from each one or group of UV LEDs 600 give out approximately the same intensity when driven at a constant current of 20 mA. The UV LEDs 600 are arranged such that there is a mixed distribution of the UVA LED 610, UVB LEDs 620, and UVC LEDs 630 wavelength band ranges when the UVABC LED light 10 is projected to a target inspection area (not shown). The UVA LED 610 is in the center with the UVB LEDs 620 and UVC LEDs 630 each placed concentrically outward from the center in an alternating pattern. This configuration would allow for the even illumination of the chemical smoke particulates that may be present in a smoke collection holder and capturing device like the proprietary Passive Covert Smoking Detector or PCSD (not shown).

FIG. 11 shows a top view of an alternate square circuit board 640 populated with UV LED 650 packages available from LG Innotek. The square circuit board 640 consists of one UVA LED 660 LEUVS33G10TZ00 385 nm 11 mW 3528 LED PKG L/F Type NUV SMD LED, five UVB LEDs 670 LEUVA66G00KF00 305 nm 10 mW 6060 PKG 1-in-1 Flat LED PKG LEDs, and five UVC LEDs 680 LEUVK37B50HF00 278 nm 2.5 mW 3535 LED PKG LEDs. The square circuit board 640 populated with LG Innotek UV LEDs 650 can be use in the alternate embodiment of a UVABC LED flood light 130 of the present invention. These UV LEDs 650 were chosen specifically with dominant wavelengths and main ranks, so that the output radiant flux from each one or group of UV LEDs 650 give out approximately the same intensity when driven at a constant current of 20 mA. The UV LEDs 650 are arranged such that there is a mixed distribution of the UVA LED 660, UVB LEDs 670, and UVC LEDs 680 wavelength band ranges when the UVABC LED light 130 is projected to a target inspection area (not shown). The UVA LED 660 is in the center with the UVB LEDs 670 and UVC LEDs 680 each placed linearly outward from the center in an alternating pattern. This configuration would allow for the even illumination of the chemical smoke particulates that may be present in a smoke collection holder and capturing device like the proprietary PCSD Passive Covert Smoking Detector.

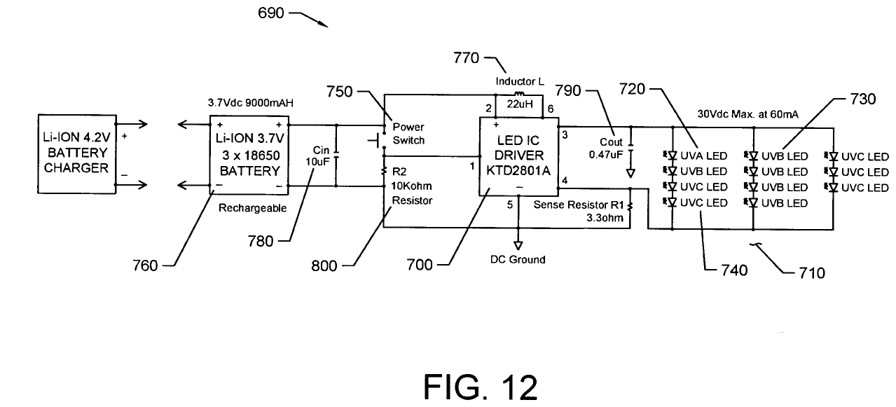

FIG. 12 shows a schematic of an alternate electrical circuit 690 used in the present invention consisting of an LED driver IC 700, UV LEDs 710 from LG Innotek, a power switch 750, and related electronic components with a rechargeable battery 760 for providing power to the UVABC LED light 10, 130. The LED driver IC 700 of choice here is the Kinetic Technologies KTD2801A 30V Step-Up LED Driver with Internal Diode and Serial Control. The LED driver IC 700 KTD2801A is a versatile constant current LED driver with a high efficiency DC-DC step up “boost” converter architecture. The low-side power MOSFET and high-side diode are integrated in the device, minimizing the total number of external components. Unique technology and high 520 mA current limit allows the LED driver IC 700 KTD2801A to drive up to 30V output with up to 8 UV LEDs 710 connected in series. The LED current is set to 60 mA using a 3.3 ohm sense resister to power three strings of UV LEDs 710 each seeing a constant current of 20 mA each. The series connection allows the LED current to be identical for uniform brightness and minimizes the number of traces to the LEDs. The LED driver IC 700 KTD2801A uses a small number of external components including a 22 uH inductor 770, a 10 uF input capacitor 780 for in the input voltage, and a 0.47 uF output capacitor 790 for the output LED voltage. One end of a 10 Kohm resistor 800 is connected to DC Ground to normally connect the LED driver IC 700 Control pin 1 to zero volts to turn off the DC output to the UV LEDs 710. The LED driver IC 700 Control pin 1 is also connected to a normally open momentary power switch 750.

The rechargeable battery 760 is rated at 3.7 Vdc, 9000 mAH and consists of three 18650 type 3000 mAH lithium-ion batteries 760 connected in parallel. The input of the LED driver IC 700 KTD2801A has a wide input voltage range of 2.7 Vdc to 5.5 Vdc. It is desirable to have a portable hand-held and battery operated UVABC light 10, 130 to operate for a relatively long time on battery 760 power before having to recharge the batteries 760. Using a combined 9000 mAH rated power source with a constant current output of 60 mA should provide battery 760 power for about 150 hours (9000/60) or 6.25 days (150/24). Since the UVABC light 10, 130 is estimated to be used for 15 minutes a day, the 150 hours of battery 760 power should allow the UVABC LED light 10, 130 to operate for 25 days (6.25/0.25) before having to recharge the batteries 760 with an external battery charger.

The output of the LED driver IC 700 KTD2801A is rated 30 Vdc at 60 mA. The UV LEDs 710 are acquired from Irtronix Inc. master distributor for LG Innotek. The UVA LED 720 is the LEUVS33G10TZ00 385 nm 11 mW 3528 LED PKG L/F Type NUV SMD LED; the UVB LED 730 is the LEUVA66G00KF00 305 nm 10 mW 6060 PKG 1-in-1 Flat LED PKG; and the UVC LED 740 is the LEUVK37B50HF00 278 nm 2.5 mW 3535 LED PKG. The forward voltage of the single UVA LED 720 is typically 3.4 Vdc; the forward voltage of each UVB LED 730 is typically 7.0 Vdc; and the forward voltage of each UVC LED 740 is typically 7.5 Vdc. The LED driver IC 700 KTD2801A supplies up to 30 Vdc at 60 mA into three LED strings of mixed or same UV LEDs 710 connected in series. Each LED strings sees about 20 mA. The first LED string consists of 1×UVA LED 720, 1×UVB LED 730, and 2×UVC LEDs 740 with a combined maximum forward voltage of 3.4v+7.0v+7.5v+7.5v totaling 25.4 Vdc. The second LED string consists of 4×UVB LEDs 730 with a combined maximum forward voltage of 4×7.0v=28.0 Vdc. The third LED string consists of 3×UVC LEDs 740 with a combined maximum forward voltage of 3×7.5v=22.5 Vdc. At 60 mA and a maximum of 30 Vdc, the UVABC LED light 10, 130 will be rated about 1.5 W using the mixed LG Innotek UV LEDs 710.

It can be appreciated that someone skilled in the art can use different types and quantities of UV LEDs 710 in the circuit boards 70, 190, 590, 640, and LED driver electronics at different currents and voltages in the circuit boards 70, 190, 590, 640 and circuit of FIG. 10, FIG. 11, and FIG. 12 above to achieve the same or similar results of the present invention for a UVABC LED light 10, 130.

It will be understood that various changes in the details, materials, types, values, and arrangements of the components that have been described and illustrated in order to explain the nature of this invention may be made by those skilled in the art without departing from the principle and scope of the invention as expressed in the following claims.

What we claim is:

1. A hand-held battery operated lighting device for the inspection, detection, and confirmation of the presence of smoke particulates produced by an act of smoking that may be found in at least one target object installed in an occupied space comprising:
at least one UVA LED;
at least one UVB LED;
at least one UVC LED;
a source of power; and
at least one switch to communicate said source of power to said at least one UVA LED, at least one UVB LED, and at least one UVC LED.

2. A hand-held battery operated lighting device according to claim 1 wherein said smoke particulates include nicotine.

3. A hand-held battery operated lighting device according to claim 1 wherein said smoke particulates include tar.

4. A hand-held battery operated lighting device according to claim 1 wherein said smoke particulates include THC.

5. A hand-held battery operated lighting device according to claim 1 wherein said smoke particulates include polycyclic aromatic hydrocarbons.

6. A hand-held battery operated lighting device according to claim 1 wherein said smoke particulates include propylene glycol and/or vegetable glycerin.

7. A hand-held battery operated lighting device according to claim 1 wherein said at least one target object is at least one smoke collection holder and capturing device.

8. A hand-held battery operated lighting device according to claim 7 wherein said at least one smoke collection holder and capturing device is at least one proprietary Passive Covert Smoking Detector or PCSD.

9. A hand-held battery operated lighting device according to claim 1 wherein said at least one target object is at least one article of clothing.

10. A hand-held battery operated lighting device according to claim 1 wherein said at least one target object is at least one carrying item.

11. A hand-held battery operated lighting device according to claim 1 wherein said at least one target object is at least one piece of furniture.

12. A hand-held battery operated lighting device according to claim 1 wherein said at least one target object is at least one exposed surface.

13. A hand-held battery operated lighting device according to claim 1 wherein said occupied space is a hotel room.

14. A hand-held battery operated lighting device according to claim 1 wherein said occupied space is a rental vehicle cabin.

15. A hand-held battery operated lighting device according to claim 1 wherein said occupied space is a cruise ship cabin.

16. A hand-held battery operated lighting device according to claim 1 wherein said occupied space is a bathroom.

17. A hand-held battery operated lighting device according to claim 1 wherein at least one UV LED is manufactured to emit all the wavelength band ranges of said at least one UVA, at least one UVB, and at least one UVC LED.

18. A hand-held battery operated lighting device according to claim 17 wherein said wavelength band ranges of said at least one UVA, at least one UVB, and at least one UVC LED includes the complete wavelength range of at least 200 nm to 400 nm.

19. A hand-held battery operated lighting device according to claim 1 wherein said source of power comes from a battery.

20. A hand-held battery operated lighting device according to claim 19 wherein said battery is a rechargeable battery.

21. A hand-held battery operated lighting device according to claim 1 wherein said switch enables the energization of said at least one UVA, at least one UVB, and at least one UVC LED individually.

22. A hand-held battery operated lighting device according to claim 21 wherein said switch enables the energization of any combination of said at least one UVA LED, at least one UVB LED, and at least one UVC LED including all of said at least one UVA LED, at least one UVB LED, and at least one UVC LEDs at the same time.

23. A hand-held battery operated lighting device according to claim 1 wherein said at least one switch is a momentary switch.

24. A method of turning losses annually into EBIDTA profits resulting from the illegal acts of smoking, the method comprising:
installation of proprietary Passive Covert Smoke Detectors (PCSD) into occupied personal spaces to collect smoke particulates from illegal acts of smoking;
using a proprietary multi-band UVABC LED light source to inspect, detect, and confirm the presence of smoke particulates resulting from the illegal acts of smoking collected and captured in said Passive Covert Smoke Detectors (PCSD);
removal and shipment of said Passive Covert Smoke Detectors (PCSD) to a certified testing lab for a Fourier Transform Infrared Spectroscopy (FTIR) test report to affirm the illegal acts of smoking were committed, and
charging back the last occupant of said personal spaces for the illegal acts of smoking for recovery of losses.

25. A portable UVABC lighting device with a power supply cord and plug for the inspection, detection, and confirmation of the presence of smoke particulates produced by an act of smoking that may be found in at least one target object installed in an occupied space comprising:
at least one UVA LED;
at least one UVB LED;
at least one UVC LED;
a source of power; and
at least one switch to communicate said source of power to said at least one UVA LED, at least one UVB LED, and at least one UVC LED.
